(19) United States
(12) Patent Application Publication
(10) Pub. No.: US 2021/0044587 A1
(43) Pub. Date: Feb. 11, 2021

(54) SYSTEM, AUTHORIZATION SERVER, CONTROL METHOD, AND STORAGE MEDIUM

(71) Applicant: CANON KABUSHIKI KAISHA, Tokyo (JP)

(72) Inventor: Jun Otsuka, Tokyo (JP)

(21) Appl. No.: 16/987,733

(22) Filed: Aug. 7, 2020

(30) Foreign Application Priority Data
Aug. 7, 2019 (JP) 2019-145573

(51) Int. Cl. H04L 29/06

(52) U.S. Cl. CPC H04L 63/0892

(57) ABSTRACT

An authorization server includes an identification unit configured to identify a user identifier from an authorization start request in response to receiving the authorization start request from a client and identify terminal information associated with the identified user identifier, a confirmation unit configured to, in a case where a plurality of pieces of terminal information are identified, transmit an authorization confirmation request to each of a plurality of user terminals owned by the user, based on the identified terminal information and receive a result of the authorization confirmation from any one of the plurality of user terminals, and an issue unit configured to control issuing of an access token in accordance with a result of the authorization confirmation received by the confirmation unit, and transmit, in a case where the access token has been issued, the issued access token to the client that has transmitted the authorization start request.

### BACKGROUND

### Field of the Disclosure

The present disclosure relates to a system, an authorization server, a control method, and a storage medium that enable authority transfer of a resource of a user.

### Description of the Related Art

Authority transfer is implemented by using OAuth2.0 in a cloud web service. Japanese Patent No. 5623234 discusses that a user can transfer authority of the user to a client by performing an authorization operation by operating both of the client and an authorization server via a web browser when setting system cooperation. The client accesses a resource of the user using the transferred authority of the user, whereby system cooperation is implemented.

### SUMMARY

According to an aspect of the present disclosure, an authorization server in a system includes a resource server configured to provide a resource of a user, a client configured to access the resource, the authorization server configured to issue an access token indicating that the client has been permitted by a user to access the resource, and a user terminal. The authorization server includes a storage unit configured to store terminal information of a plurality of user terminals in association with a user identifier of one user, an identification unit configured to identify a user identifier from an authorization start request in response to receiving the authorization start request from the client, and identify terminal information associated with the identified user identifier, a confirmation unit configured to, in a case where a plurality of pieces of terminal information are identified, transmit an authorization confirmation request to each of a plurality of user terminals owned by the user, based on the identified terminal information, and receive a result of authorization confirmation from any one of the plurality of user terminals, and an issue unit configured to control issuing of the access token in accordance with a result of authorization confirmation that has been received by the confirmation unit, and transmit the issued access token to the client that has transmitted the authorization start request in a case where the access token has been issued.

Further features of the present disclosure will become apparent from the following description of exemplary embodiments with reference to the attached drawings.

### BRIEF DESCRIPTION OF THE DRAWINGS

FIG. 1 is a block diagram illustrating a network configuration.

FIG. 2 is a block diagram illustrating a configuration of an authorization server according to one or more aspects of the present disclosure.

FIGS. 3A, 3B, 3C, and 3D are block diagrams illustrating module configurations according to one or more aspects of the present disclosure.

FIGS. 4A, 4B, 4C, and 4D are flowcharts illustrating procedures of an authorization start request and an authorization confirmation request according to one or more aspects of the present disclosure,

FIGS. 5A, 5B, 5C, and 5D are flowcharts illustrating procedures of access token issue according to one or more aspects of the present disclosure,

FIG. 6 is a block diagram illustrating an overall flow according to one or more aspects of the present disclosure.

FIG. 7 is a diagram illustrating an authorization confirmation screen according to one or more aspects of the present disclosure.

### DESCRIPTION OF THE EMBODIMENTS

For transferring an authority of a user to a client in OAuth2.0, the user needs to access the client via a web browser. For example, assume a case where, in a multitenant system, for analyzing data of each tenant from an external system, the permission of an administrator of each tenant is required, in this case, an administrator of a tenant cannot be expected to access an external system serving as a client, at a timing of analysis processing, and the client needs to autonomously make a request for authority transfer.

By the client autonomously making a request for authority transfer, even in a state in which a user does not access the client, the client can designate a user and require the user to transfer the authority. However, when the permission for authority transfer is requested, it is necessary to identify which terminal of a user is to be required for permission of authority transfer.

The present disclosure is directed to a system of identifying a terminal of a user and requesting permission for authority transfer when the client designates the user and requests authority transfer from the user.

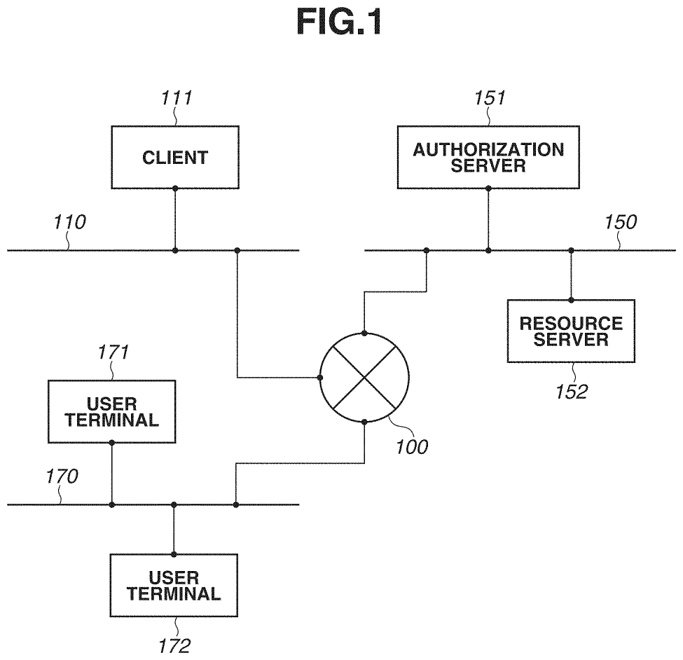

An exemplary embodiment of the present disclosure will be described with reference to the drawings. An authority transfer system according to an exemplary embodiment is implemented on a network having a configuration as illustrated in FIG. 1. A WorldWide Web (WWW) system is constructed as a wide area network (WAN) 100 in the present exemplary embodiment, Local area networks (LANs) 110, 150, and 170 connect the components.

A resource server 152 manages resources of the user and a client 111 accesses resources on the resource server 152. For the client 111 accessing the resources on the resource server 152, authority transfer by a resource owner is necessary. In response to a request from the client, an authorization server 151 issues an access token serving as an evidence of permission for access to the resource. User terminals 171 and 172 display an authorization confirmation screen When the client 111 requests authority transfer. Although only two user terminals are illustrated in FIG. 1, three or more user terminals may be provided.

The authorization server 151 and the resource server 152 are connected to the WAN 100 via the LAN 150. Similarly, the client 111 and the user terminal 171 are connected to the WAN 100 via the LAN 110 and the LAN 170, respectively. The authorization server 151 and the resource server 152 may be provided on the different LANs, or may be provided on the same LAN. Similarly, the authorization server 151 and the resource server 152 may be provided on the same personal computer (PC) or the same server computer. In addition, FIG. 1 illustrates one authorization server 151 and one resource server 152, but the authorization server 151 and the resource server 152 may each be a server system including a plurality of servers. For example, the authorization server 151 may be constructed by clustering a plurality of servers. In the present exemplary embodiment, a server system refers to an apparatus that includes at least one server and provides a specific service.

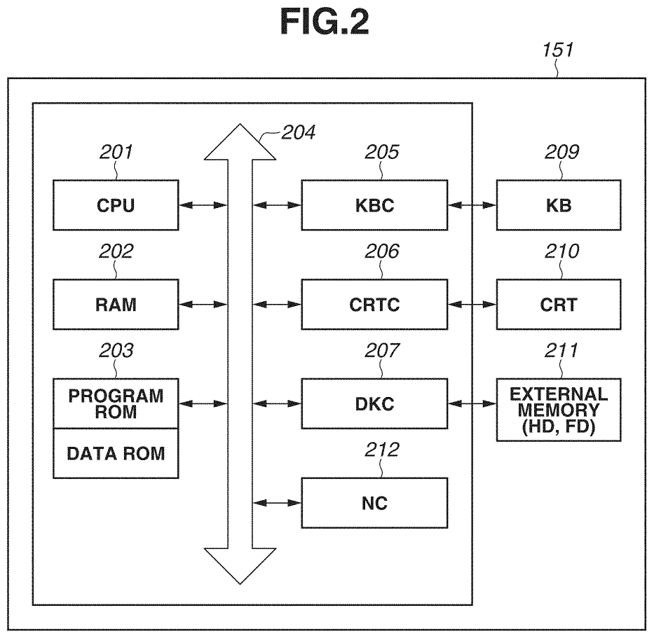

An event notification system according to a first exemplary embodiment is implemented on a system including a PC having a configuration as illustrated in FIG. 2. FIG. 2 is a block diagram illustrating a configuration of the authorization server 151 according to a first exemplary embodiment, In addition, the configurations of the client 111 and the resource server 152 and the configuration of the user terminal 171 are similar to the configuration illustrated in FIG. 2. A hardware block diagram illustrated in FIG. 2 is equivalent to a hardware block diagram of a common information processing apparatus, and a hardware configuration of a common information processing apparatus can be applied to a server computer and a terminal according to the present exemplary embodiment.

In FIG. 2, a central processing unit (CPU) 201 executes a program such as an operating system (OS) and an application that are stored in a program read-only memory (ROM) of a ROM 203 or loaded from a hard disk (HD) 211 onto a random access memory (RAM) 202, Processing in each flowchart to be described below can be implemented by the execution of the program. The RAM 202 functions as a main memory and a work area of the CPU 201. A keyboard controller (KBC) 205 controls a key input from a keyboard (KB) 209 or a pointing device (not illustrated). A cathode-ray tube controller (CRTC) 206 controls the display of a CRT display 210. A disk controller (DKC) 207 controls data access to the HD 211 and a floppy disk (FD) that store various types of data. A network controller (NC) 212 is connected to a network and executes communication control processing with another device connected to the network.

In all of the following descriptions, unless otherwise noted, a hardware component that executes processing is the CPU 201, and a software component that executes processing is programs of an OS and an application that are installed on the HD 211 or the ROM 203. The software component is implemented by the CPU 201 executing these programs.

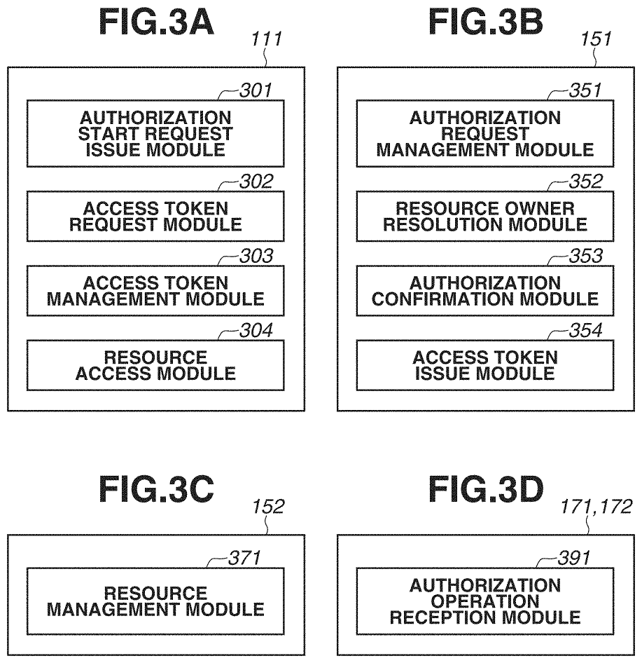

FIGS. 3A, 3B, 3C, and 3D are diagrams respectively illustrating module configurations of the client 111, the authorization server 151, the resource server 152, and the user terminals 171 and 172 according to the present exemplary embodiment, FIGS. 3A, 3B, and 3C are block diagrams respectively illustrating module configurations of the client 111, the authorization server 151, and the resource server 152. In addition, FIG. 3D is a block diagram illustrating a module configuration of the user terminals 171 and 172.

The client 111 includes an authorization start request issuance module 301, an access token request module 302, an access token management module 303, and a resource access module 304. The authorization server 151 includes an authorization request management module 351, a resource owner resolution module 352, an authorization confirmation module 353, and an access token issue module 354. The resource server 152 includes a resource management module 371. The user terminal 171 includes an authorization operation reception module 391.

The authorization request management module 351 of the authorization server 151 processes an authorization start request in accordance with a request from the authorization start request issuance module 301 of the client 111. The authorization start request includes resource information to be accessed by the client 111. Using the resource information included in the authorization start request, the resource owner resolution module 352 inquires of the resource server 152 about resource owner information of the resource. Based on the resource owner information obtained at this time, the authorization confirmation module 353 makes an authorization confirmation request to a specific user terminal 171. If the user performs an authorization operation in response to the authorization confirmation request, it becomes possible for the client 111 to acquire an access token from the authorization server 151 and access the resource of the user provided by the resource server. In this manner, the authorization server 151 includes modules for executing authorization processing for the client 111 accessing the resource related to the user.

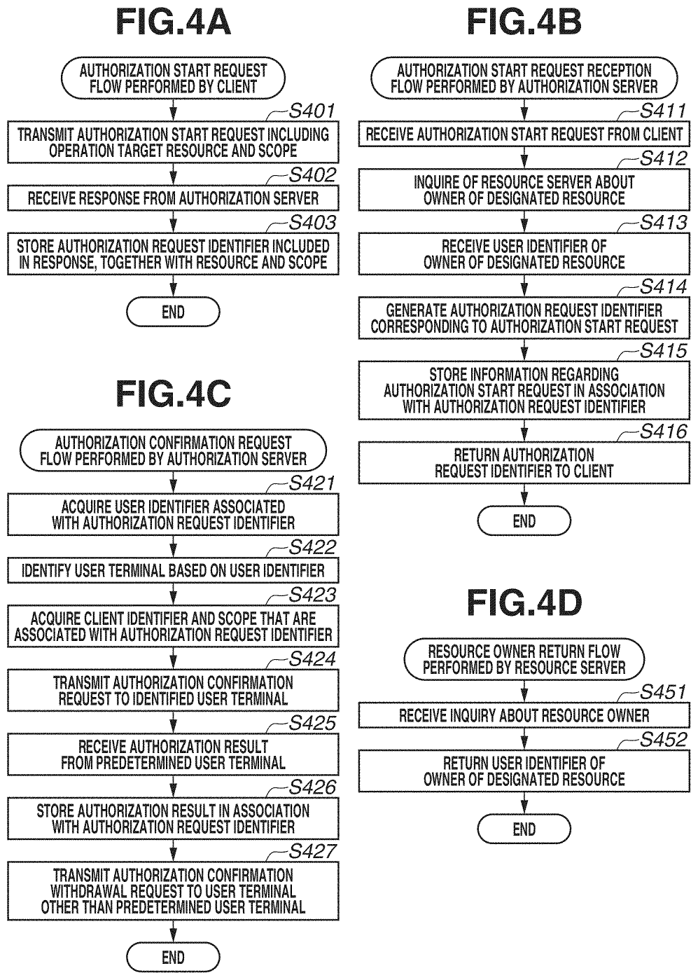

FIG. 4A is a flowchart illustrating a procedure for the client 111 making an authorization start request to the authorization server 151 according to the present exemplary embodiment. The flowchart is started when an access token becomes necessary for the client 111 accessing the resource on the resource server 152.

In step S401, the authorization start request issuance module 301 transmits an authorization start request including an operation target resource identifier and a scope, to the authorization server 151. The scope indicates a range of access to a resource. For example, when the acquisition of a resource is desired, a scope of “get-data” is designated.

In step S402, the authorization start request issuance module 301 receives a response from the authorization server 151. The response includes an authorization request identifier issued by the authorization server 151. In step S403, the authorization start request issuance module 301 stores the authorization request identifier included in the response received in step S402, together with the operation target resource and the scope that have been transmitted in step S401, and ends the flow. Table 1 indicates an example of an authorization request management table stored by the client 111.

TABLE 1
Authorization request management table

| Authorization request | | | Access token |
|---|---|---|---|
| identifier | Resource identifier | Scope | identifier |
| auth_req_id_12345 | /datalake/iot0010/data | get- | (Blank) |
| | | data | |
| auth_req_id_98765 | /datalake/iot0011/data | get- | actk111222333 |
| | | data | |
| : | : | : | : |

In Table 1, an authorization start request made with a scope “get-data” for a resource indicated by a resource identifier “/datalake/iot0010/data” is stored in association with an authorization request identifier “auth_req_id_12345”. In addition, Table 1 indicates that an access token indicated by an access token identifier “actk111222333” has been acquired in response to an authorization start request indicated by an authorization request identifier “auth_req_id_98765”. In Table 1, a resource indicated by a resource identifier may indicate one file on a file system, or may indicate a specific record on a database. Alternatively, the resource may indicate an aggregate of files or records.

FIG. 4B is a flowchart illustrating an authorization start request reception flow performed by the authorization server 151 according to the present exemplary embodiment. This flowchart is started by the authorization server 151 receiving an authorization start request from the client 111. In step S411, the authorization request management module 351 receives an authorization start request from the client 111. The authorization start request includes a client identifier of the client 111 and a resource identifier of an operation target resource to be accessed by the client 111.

In step S412, the resource owner resolution module 352 inquires of the resource server 152 about an owner of the resource designated in step S411 In step S413, the resource owner resolution module 352 receives a user identifier of an owner of the resource designated in step S411, as a response to the inquiry made in step S412. In step S414, the authorization request management module 351 generates an authorization request identifier corresponding to the authorization start request received in step S411.

In step S415, the authorization request management module 351 stores information regarding an authorization start request in association with the authorization request identifier generated in step S414. The information regarding an authorization start request includes the client identifier, the operation target resource identifier, and the scope that have been received in step S411, and the user identifier received in step S413. Table 2 indicates an example of an authorization confirmation status management table stored by the authorization request management module 351.

TABLE 2
Authorization confirmation status management table

| Authorization | Client | | | User | Authorization |
|---|---|---|---|---|---|
| request identifier | identifier | Resource | Scope | identifier | result |
| auth_req_id_12345 | client_xyz | /datalake/iot0010/data | get- | user_abcde | (blank) |
| | | | data | | |
| | client_xyz | /datalake/iot0011/data | get- | user_abcde | approved |
| | | | data | | |
| auth_req_id_44444 | client_xyz | /datalake/iot0011/data | get- | user_abcde | disapproved |
| | | | all | | |
| : | : | : | : | : | : |

In Table 2, an authorization start request made with a scope “get-data” for a resource indicated by a resource identifier “/datalake/iot0010/data”, by a client indicated by a client identifier “client_xyz” is stored in association pith an authorization request identifier “auth_req_id_12345”. In addition, a user identifier “user_abcde” is associated with the authorization request identifier “auth_req_id_12345”. This indicates that the user identifier “user abcde” has been acquired as a result of resolving a resource owner of the resource indicated by the resource identifier “/datalake/iot0010/data”. An authorization result “(blank)” associated with the authorization request identifier “auth_req_id_12345” indicates that the user has not performed an authorization operation yet.

In contrast to this, an authorization result associated with an authorization request identifier “auth_req_id_98765” indicates “approved”, and an authorization result associated with an authorization request identifier “auth_req_id_44444” indicates “disapproved”. These authorization results respectively indicate that the user has authorized a corresponding client and that the user has refused to authorize a corresponding client. In this manner, pieces of information are associated with each other.

In step S416, the authorization request management module 351 returns the authorization request identifier generated in step S414, to the client 111 as a response to the authorization start request received in step S411, and ends the flow.

FIG. 4C is a flowchart illustrating a procedure for making an authorization confirmation request in the authorization server 151 according to the present exemplary embodiment. The flowchart is started when the information regarding an authorization start request is stored in step S415.

In step S421, the authorization confirmation module 353 acquires a user identifier associated with the authorization request identifier stored in step S415. If the authorization request identifier stored in step S415 is “auth_req_id_12345”, a user identifier associated with the authorization request identifier is “user_abcde”.

In step S422, the authorization confirmation module 353 identifies a plurality of user terminals 171 and 172 based on the user identifier acquired in step S421. Table 3 indicates an example of a user management table storing a correspondence between a user identifier and the user terminal 171. Table 3 indicates that one user owns two user terminals, but one user may own three or more user terminals. In this case, three or more pieces of user terminal information are associated with a user identifier of the one user.

TABLE 3
User management table

| User identifier | User terminal information |
|---|---|
| user_abcde | 192.168.0.1 |
| | 192.168.0.2 |
| | 192.168.03 |
| user_klmno | 192.168.0.4 |
| : | : |

From Table 3, it can be identified that the user terminal information corresponding to the user identifier “user_abcde” is “192.168.0.1” and “192.168.0.2”. In the present exemplary embodiment, the description will be given assuming that the two user terminals indicated by the user terminal information correspond to the user terminals 171 and 172. In step S423, the authorization confirmation module 353 acquires a client identifier and a scope that are associated with the authorization request identifier stored in step S415. At this time, if the authorization request identifier stored in step S415 is “auth_req_id_12345”, a client identifier and a scope that are associated with the authorization request identifier are “client_xyz” and “get-data.”, respectively.

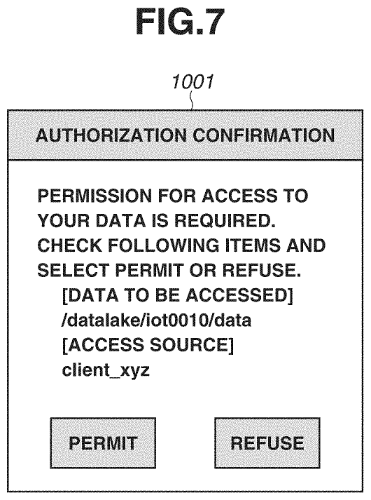

In step S424, the authorization confirmation module 353 transmits an authorization confirmation request including the client identifier and the scope that have been acquired in step S423, to the user terminals 171 and 172 identified in step S422, The transmission method of the authorization confirmation request may be a communication method of designating an end point of the user terminal 171, or may be a method that uses a PUSH notification including message queuing telemetry transport (MQTT). Alternatively, the transmission method may be another method. The authorization operation reception module 391 of the user terminals 171 and 172 that has received the authorization confirmation request displays an authorization confirmation screen 1001 as illustrated in FIG. 7, and requires the user to perform an authorization operation. An important point lies in that the authorization confirmation screen 1001 is displayed on all user terminals owned by the user. The user issues an authorization instruction by pressing a “permit” button on the authorization confirmation screen 1001.

In step S425, the authorization confirmation module 353 receives an authorization result from a predetermined user terminal (user terminal 171 or 172), as a response to the authorization confirmation request transmitted in step S424. In step S426, the authorization confirmation module 353 stores the authorization result received in step S425, in association with the authorization request identifier stored in step S415, and ends the flow. In Table 2, an authorization result “approved” indicating that a corresponding client has been authorized is stored in association with the authorization request identifier “auth_req_id_98765”.

In step S427, the authorization confirmation module 353 transmits an authorization confirmation withdrawal request to a user terminal other than the predetermined user terminal. For example, when a user performs an authorization operation from a user terminal with user terminal information “192.168.0.1”, the authorization confirmation module 353 transmits an authorization confirmation withdrawal request to a user terminal with user terminal information “192.168.0.2”, which is another user terminal associated with the user. When the user owns three or more user terminals, the authorization confirmation module 353 transmits an authorization confirmation withdrawal request to all user terminals other than a user terminal from which an authorization operation has been performed. In addition, irrespective of whether the authorization operation of the user is “permit” or “refuse”, regardless of a result of the authorization operation, the authorization confirmation module 353 transmits an authorization confirmation withdrawal request to a user terminal other than the predetermined user terminal. Only by performing an authorization operation in response to the current authorization request, the user can avoid erroneously performing an authorization operation from another user terminal in response to the same authorization request.

FIG. 4D is a flowchart illustrating a procedure for returning a resource owner in the resource server 152 according to the present exemplary embodiment. The flowchart is started when the resource server 152 receives an inquiry about a resource owner from the authorization server 151.

In step S451, the resource management module 371 receives an inquiry about a resource owner from the authorization server 151. The inquiry includes a resource identifier. In step S452, the resource management module 371 acquires the user identifier of the owner of the resource designated in step S415, returns the user identifier to the authorization server 151, and ends the flow. Table 4 indicates an example of a resource management table in the resource management module 371.

TABLE 4
Resource management table

| Resource identifier | User identifier |
|---|---|
| /datalake/iot0010/data | user_abcde |
| /datalake/iot0011/data | user_abcde |
| : | : |

In Table 4, a resource identifier is employed as identification information for identifying a resource. Table 4 indicates that an owner of a resource indicated by a resource identifier “/datalake/iot0010/data” is a user with a user identifier “user_abcde”.

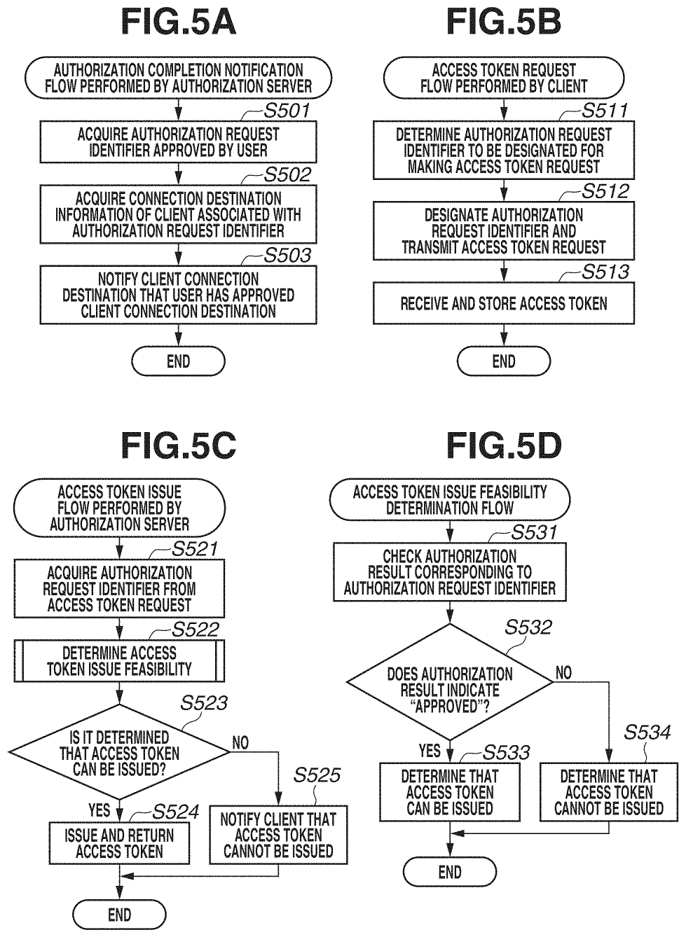

FIG. 5A is a flowchart illustrating a procedure for the authorization server 151 providing an authorization completion notification to the client 111 according to the present exemplary embodiment. The flowchart is started when an authorization result is stored in step S426.

In step S501, the authorization confirmation module 353 acquires the authorization request identifier stored in step S426. In step S502, the authorization confirmation module 353 acquires a client end point that is connection destination information of a client associated with the authorization request identifier acquired in step S501. Table 5 indicates an example of a client management table for managing a correspondence between a client identifier and a client end point.

TABLE 5
Client management table

| Client identifier | Client end point |
|---|---|
| client_xyz | 10.0.0.1 |
| client_aaa | 10.0.1.1 |
| client_bbb | 10.0.2.1 |
| : | : |

Table 5 indicates that a client end point associated with a client with a client identifier “client_xyz” is “10.0.0.1”. In step S503, the authorization confirmation module 353 notifies the client end point acquired in step S502 that the user has permitted access to a resource, i.e., that the user has approved the client end point, and ends the flow. information included in the notification provided to the client end point may include the authorization request identifier acquired in step S501, or may include an access token issued in response to the authorization performed by the user. When an access token is issued, a flow to be described below with reference to FIG. 5C is executed.

FIG. 5B is a flowchart illustrating a procedure for the client 111 making an access token request to the authorization server 151 according to the first exemplary embodiment. The flowchart is started when the client 111 receives an authorization completion notification from the authorization server 151 in step S503. In addition, the flowchart may be periodically executed by the client 111.

In step S511, the access token request module 302 determines an authorization request identifier for making an access token request. If the flowchart is periodically executed, an authorization request identifier is selected from among authorization request identifiers for which an access token has not been acquired yet in the authorization request management table indicated as Table 1. In addition, if the flowchart is started when a notification is received from the authorization server 151, an authorization request identifier included in the notification from the authorization server 151 is used.

In step S512, the access token request module 302 designates the authorization request identifier determined in step S511, and makes an access token request to the authorization server 151, In step S513, the access token management module 303 stores an access token received as a response to the access token request transmitted in step S512, and ends the flow. Table 1 indicates a state in which an access token with an access token identifier “actk111222333” that has been acquired for an authorization request identifier “auth_req_id_98765” is stored.

FIG. 5C is a flowchart illustrating a procedure for the authorization server 151 issuing an access token according to the present exemplary embodiment. The flowchart is started when the authorization server 151 receives an access token request from the client 111.

In step S521, the access token issue module 354 acquires an authorization request identifier from the access token request received from the client 111. In step S522, the access token issue module 354 determines access token issue feasibility.

In step S523, the access token issue module 354 checks whether it is determined that an access token can be issued, as a result of the determination in step S522. If it is determined that an access token can be issued (YES in step S523), the processing proceeds to step S524. On the other hand, if it is determined that an access token cannot be issued (NO in step S523), the processing proceeds to step S525.

In step S524, the access token issue module 354 issues an access token corresponding to a user identifier and a scope that are associated with the authorization request identifier acquired in step S521. In addition, the access token issue module 354 returns the issued access token to the client 111, and ends the flow. Table 6 indicates an example of an access token management table for managing an access token issued by the access token issue module 354.

TABLE 6
Access token management table

| Access token identifier | User identifier | Scope |
|---|---|---|
| actk111222333 | user_abcde | get-data |
| : | : | : |

Table 6 illustrates a state where an access token indicating that a user with a user identifier “user_abcde” has performed authority transfer of a scope “get-data” has been issued as an access token with an access token identifier “actk111222333”. The access token to be returned to the client 111 in step S524 may be only an access token identifier, or may be structured data including a user identifier and a scope in addition to an access token identifier. in step S525, the access token issue module 354 notifies the client 111 that an access token cannot be issued, and ends the flow.

FIG. 5D is a flowchart illustrating a detailed procedure fir making an access token issue feasibility determination in step S522 according to the present exemplary embodiment. In step S531, the access token issue module 354 refers to the authorization confirmation status management table indicated as Table 2, and checks an authorization result corresponding to the designated authorization request identifier.

In step S532, the access token issue module 354 determines whether the authorization result checked in step S531 indicates “approved”. if the authorization result indicates “approved” (YES in step S532), the processing proceeds to step S533. Otherwise (NO in step S532), the processing proceeds to step S534. In step S533, the access token issue module 354 determines that an access token can be issued, and ends the flow. In step S534, the access token issue module 354 determines that an access token cannot be issued, and ends the flow.

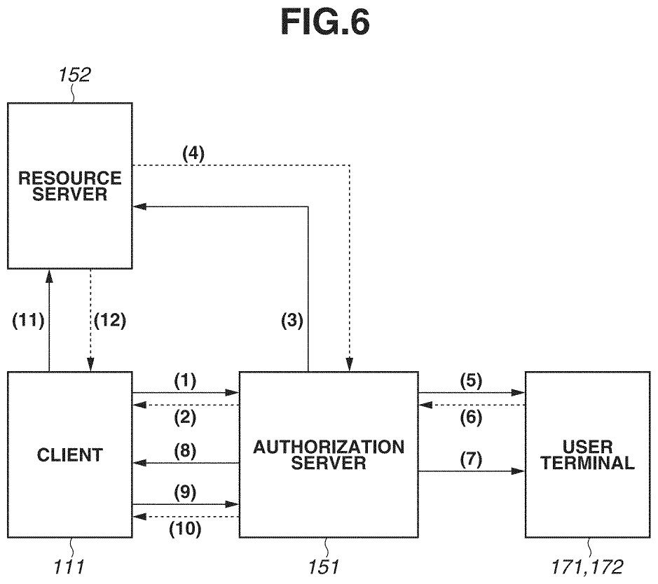

FIG. 6 is a block diagram illustrating an overall flow of a client making an authorization start request, acquiring an access token, and accessing a resource according to the present exemplary embodiment. The client 111 makes an authorization start request to the authorization server 151 in flow (1), and acquires an authorization request identifier as a response in flow (2). Flow (1) corresponds to steps S401 and S411, and flow (2) corresponds to steps S402 and S416.

If the authorization server 151 receives the authorization start request, for resolving a resource owner with a resource identifier included in the authorization start request, the authorization server 151 inquires of the resource server 152 about a resource owner in flow (3). In addition, the authorization server 151 receives a user identifier of a resource owner as a response in flow (4). Flow (3) corresponds to steps S412 and S451, and flow (4) corresponds to steps S413 and S452.

If the authorization server 151 has completed the resolution of a resource owner, in flow (5), the authorization server 151 makes an authorization confirmation request to the user terminals 171 and 172 associated with the resource owner. In the user terminals 171 and 172, the authorization confirmation screen 1001 illustrated in FIG. 7 is displayed, and the user performs an authorization operation from any one user terminal. The user performs an authorization operation by selecting “permit” on the authorization confirmation screen 1001 if the user permits the client 111 to access the resource of the user, or selecting “refuse” on the authorization confirmation screen 1001 if the user refuses the access. A result of the authorization operation performed by the user is returned to the authorization server 151 as flow (6). Flow (5) corresponds to step S424 and flow (6) corresponds to step S425.

If the authorization server 151 receives the authorization result in flow (6), the authorization server 151 transmits in flow (7) an authorization confirmation withdrawal request to all user terminals owned by the user that exclude a user terminal from which the user has performed an authorization operation. A user terminal that has received the authorization confirmation withdrawal request stops the display of the authorization confirmation screen 1001 that is being displayed. Then, the authorization server 151 provides an authorization completion notification to the client 111 in flow (8). Flow (8) corresponds to step S503.

The client 111 receives the authorization completion notification in flow (8), or periodically makes an access token request to the authorization server 151 in flow (9). In addition, the client 111 receives an access token as a response in flow (10). Flow (9) corresponds to steps S512 and S521, and flow (10) corresponds to steps S513 and S524.

The client 111 that has received an access token in flow (5) or flow (10) accesses a resource on the resource server 152 in flow (11), and acquires the resource as a response in flow (12). The resource server 152 transmits an access token verification request to the authorization server 151 to require the authorization server 151 to perform verification, or the resource server 152 verifies the access token for itself, and checks whether the client 111 is permitted to access the resource of the user. The range of access to the resource is determined based on the scope. For example, if the scope is a “get-data” scope, the resource server 152 provides the resource of the user to the client 111.

According to the first exemplary embodiment, even if a resource desired to be accessed by a client is identified but an owner of the resource is unidentified, it becomes possible to make an authorization start request. In addition, it is possible to identify a terminal of a user and request permission for authority transfer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to he accorded the broadest interpretation so as to encompass all such modifications and equivalent structures and functions.

This application claims the benefit of Japanese Patent Application No. 2019-145573, filed Aug. 7, 2019, which is hereby incorporated by reference herein in its entirety.

What is claimed is:

1. An authorization server in a system including a resource server configured to provide a resource of a user, a client configured to access the resource, the authorization server configured to issue an access token indicating that the client has been permitted by a user to access the resource, and a user terminal, the authorization server comprising:
a storage unit configured to store terminal information of a plurality of user terminals in association with a user identifier of one user;
an identification unit configured to identify a user identifier from an authorization start request in response to receiving the authorization start request from the client, and identify terminal information associated with the identified user identifier;
a confirmation unit configured to, in a case where a plurality of pieces of terminal information are identified, transmit an authorization confirmation request to each of a plurality of user terminals owned by the user, based on the identified terminal information, and receive a result of authorization confirmation from any one of the plurality of user terminals, and
an issue unit configured to control issuing of the access token in accordance with a result of authorization confirmation that has been received by the confirmation unit, and transmit the issued access token to the client that has transmitted the authorization start request in a case where the access token has been issued.

2. The authorization server according to claim 1, wherein, by the authorization confirmation request being transmitted to each of the plurality of user terminals by the confirmation unit, an authorization confirmation screen is displayed on each of displays of the plurality of user terminals.

3. The authorization server according to claim 1, wherein, in response to receiving a result of authorization confirmation from any one of the plurality of user terminals, the confirmation unit transmits an authorization confirmation withdrawal request to a user terminal owned by the user that that is different from the user terminal that has transmitted a result of authorization confirmation.

4. The authorization server according to claim 3, wherein the confirmation unit transmits, regardless of a result of authorization confirmation, an authorization confirmation withdrawal request to a user terminal owned by the user that is different from the user terminal that has transmitted a result of authorization confirmation.

5. The authorization server according to claim 3, wherein, by the authorization confirmation withdrawal request being transmitted to the user terminal by the confirmation unit, display of an authorization confirmation screen that has been displayed on a display of the user terminal owned by the user that is different from the user terminal that has transmitted the result of the authorization confirmation is stopped.

6. The authorization server according to claim 1, wherein the identification unit identifies a user identifier from identification information of the resource to be accessed by the client that is included in the authorization start request, and identifies terminal information associated with the identified user identifier.

7. A non-transitory storage medium storing a program for controlling an authorization server in a system including a resource server configured to provide a resource of a user, a client configured to access the resource, the authorization server configured to issue an access token indicating that the client has been permitted by a user to access the resource, and a user terminal, the program controlling the authorization server to execute:
storing terminal information of a plurality of user terminals in association with a user identifier of one user;
identifying a user identifier from an authorization start request in response to receiving the authorization start request from the client, and identifying terminal information associated with the identified user identifier;
transmitting, in a case where a plurality of pieces of terminal information are identified, an authorization confirmation request to each of a plurality of user terminals owned by the user, based on the identified terminal information, and receiving a result of authorization confirmation from any one of the plurality of user terminals; and
controlling issuing of the access token in accordance with a result of authorization confirmation that has been received in the receiving, and transmitting, in a case where the access token has been issued, the issued access token to the client that has transmitted the authorization start request.

8. The non-transitory storage medium according to claim 7, wherein, by the authorization confirmation request being transmitted to each of the plurality of user terminals in the transmitting, an authorization confirmation screen is displayed on each of displays of the plurality of user terminals.

9. The non-transitory storage medium according to claim 8, wherein, by the authorization confirmation withdrawal request being transmitted to the user terminal in the transmitting, display of an authorization confirmation screen that has been displayed on a display of the user terminal owned by the user that is different from the user terminal that has transmitted the result of the authorization confirmation is stopped.

10. The non-transitory storage medium according to claim 7, wherein transmitting, in response to receiving a result of authorization confirmation from any one of the plurality of user terminals, an authorization confirmation withdrawal request to a user terminal owned by the user that is different from the user terminal that has transmitted a result of authorization confirmation.

11. The non-transitory storage medium according to claim 10, wherein, regardless of a result of authorization confirmation, an authorization confirmation withdrawal request is transmitted to a user terminal owned by the user that is different from the user terminal that has transmitted a result of authorization confirmation.

12. The non-transitory: storage medium according to claim 7, wherein a user identifier is identified from identification information of the resource to be accessed by the client that is included in the authorization start request, and terminal information associated with the identified user identifier is identified.

13. A control method of a system including a resource server configured to provide a resource of a user, a client configured to access the resource, an authorization server configured to issue an access token indicating that the client has been permitted by a user to access the resource, and a user terminal,
the control method controlling the authorization server to execute:
storing terminal information of a plurality of user terminals in association with a user identifier of one user;
identifying a user identifier from an authorization start request in response to receiving the authorization start request from the client, and identifying terminal information associated with the identified user identifier;
transmitting, in a case where a plurality of pieces of terminal information are identified, an authorization confirmation request to each of a plurality of user terminals owned by the user, based on the identified terminal information, and receiving a result of authorization confirmation from any one of the plurality of user terminals; and
controlling issuing of the access token in accordance with a result of the received authorization confirmation, and transmitting, in a case where the access token has been issued, the issued access token to the client that has transmitted the authorization start request, and
the control method controlling the user terminal to execute:
displaying an authorization confirmation screen for receiving an instruction for permitting the client to access the resource or refusing access to the resource, in response to receiving the authorization confirmation request; and
transmitting, to the authorization server, a result of authorization confirmation indicating that access has been permitted, in a case where access has been permitted, and a result of authorization confirmation indicating that access has been refused, in a case where access has been refused.
